(19) United States
(12) Patent Application Publication
(10) Pub. No.: US 2012/0158813 A1
(43) Pub. Date: Jun. 21, 2012

(54) SERVICE ABSTRACTION LAYER FOR ACCESSING A PLURALITY OF SERVICES

(76) Inventors: Udaya Kumar, Dublin (IE); Peer Hilgers, St. Leon-Rot (DE); Thomas Spangemacher, Hockenheim (DE); Julien Weber, Asnieres-sur-Seine (FR)

(21) Appl. No.: 12/969,657

(22) Filed: Dec. 16, 2010

(51) Int. Cl. G06F 15/16

(52) U.S. Cl. 709/201

(57) ABSTRACT

Various embodiments of systems and methods for accessing a plurality of services using a service abstraction layer are described herein. A plurality of services from one or more service provider is registered in a service abstraction layer. A request, from a service requestor, for accessing at least one service of the registered plurality of services is received at the service abstraction layer. Further, the received service request, at a service invoker of the service abstraction layer is forwarded to at least one corresponding service provider. Furthermore, successful execution of the requested service by the corresponding service providers is determined at the service invoker. Based on the determination, a response from the corresponding service provider is returned to the service requestor. Therefore, communication between the service requestor and the multiple service providers is handled by the service abstraction layer, which acts as a centralized layer.

### FIELD

Embodiments generally relate to computer systems and more particularly to methods and systems for accessing a plurality of services using a service abstraction layer.

### BACKGROUND

One of the primary factors considered in accessing software applications is ease of use and the quality of user experience that they provide. Therefore, modern applications give high priority to providing a user interface (UI) that adapts, responds and expands rapidly and in an agile way to new functionality and to ever changing user requirements. However, increase in demand for services offered by various service providers has raised one or more drawbacks as follows.

The life-cycle of such service requests is implicitly tied to the UI of the user component. Therefore, such life-cycle management can create unnecessary complexity due to a number of design considerations, and an inelegant reflection of the underlying data model. For example, modifying UI component to reflect the changes in the service provider, retrying the request or raising an alert when there is no response or when service is unavailable, and updating the UI by reflecting the changes of data when there is a response. Therefore, a centralized model for managing the communication between the client and different service providers is desirable.

### SUMMARY

Various embodiments of systems and methods for accessing a plurality of services using a service abstraction layer are described herein. In one aspect, a plurality of services from one or more service providers is registered in a service abstraction layer. At least one request for accessing at least one service of the registered plurality of services is received from a service requestor at the service abstraction layer. Further, the received request is forwarded to at least one corresponding service provider of the one or more service providers by a service invoker of the service abstraction layer. Furthermore, successful execution of the requested service by the at least one corresponding service provider is determined at the service invoker. Based on the determination, a response from the at least one corresponding service provider is returned to the service requestor. If the requested service is successfully executed, at least one of updating a user interface (UI) with a response received from the corresponding service provider and storing the response from the corresponding service provider is performed, depending on a response callback handler type. If the requested service is not successfully executed, the request is stacked for execution for a predetermined number of attempts. If the requested service is not successfully executed by the corresponding service provider after the predetermined number of attempts, the service requestor is updated with an error message.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram illustrating a method of accessing a plurality of services using a service abstraction layer, according to an embodiment.

FIG. 2 is a flow diagram illustrating a method of implementation when a requested service is successfully executed by a service provider, according to an embodiment.

FIG. 3 is a flow diagram illustrating a method of implementation when a requested service is not successfully executed by a service provider, according to an embodiment.

FIG. 4 is a block diagram of a conceptual illustration of a system for accessing a plurality of services using a service abstraction layer, according to an embodiment.

FIG. 5 is a block diagram illustrating a computing environment describing the techniques for accessing a plurality of services using a service abstraction layer, according to an embodiment.

### DETAILED DESCRIPTION

Embodiments of techniques for accessing a plurality of services using a service abstraction layer are described herein. The plurality of services can be offered by different service providers. The service providers are the end points for providing information upon receiving a request, typically servers. Further, the service providers can reside in a particular landscape or in a cloud. According to an embodiment, the plurality of services offered by different service providers is registered in the service abstraction layer. The service abstraction layer is built in between a client or a service requestor and the multiple service providers. Further, when a request is received at the service abstraction layer, the request is forwarded to a corresponding service provider. In turn, a response from the corresponding service provider is updated to the service requestor using the service abstraction layer. Therefore, communication between the service requestor and the multiple service providers is handled completely by the service abstraction layer, which acts as a centralized layer.

In one embodiment, a common format of data representation, error handling, queuing, and the like required for communication between the service requestor and the multiple service providers can be achieved by the service abstraction layer. Also, using a single request, the service abstraction layer can transmit the command to the different service providers. The service abstraction layer enables a clear service requestor and service provider relationship, reduces the presence of critical dependency blocks, and hides the complexities of the communication (e.g., how the request is handled, a method of handshake, and the like) and possibly data-conversion logic for each service request. Therefore, the service abstraction layer ensures a robust, rapid, agile and loosely coupled relationship between a user interface (UI) of the service requestor and the multiple service providers. Also, the service abstraction layer enables the service requestor to access different services in a highly decoupled and technology independent fashion.

In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

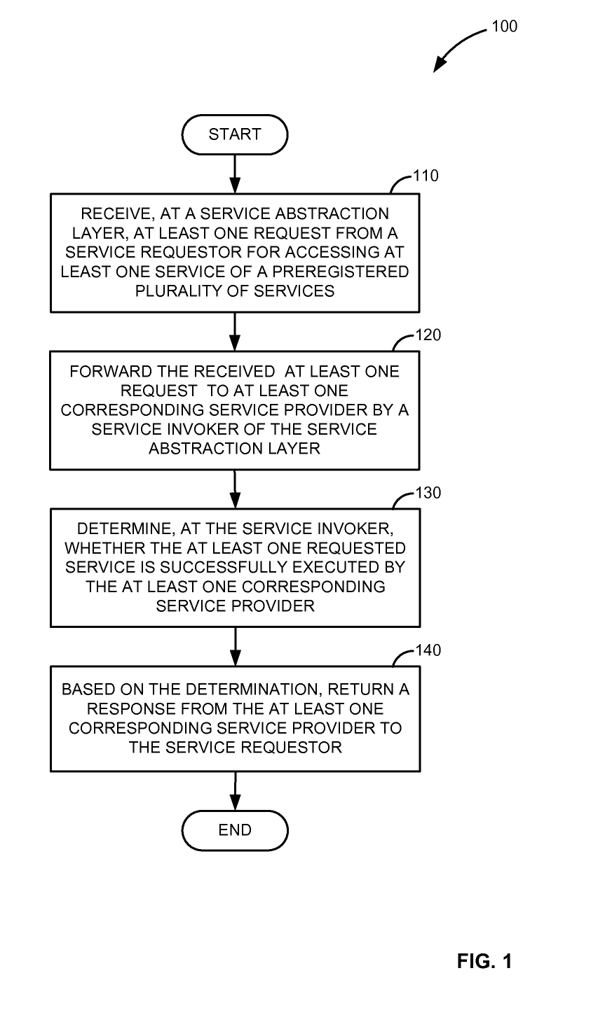

FIG. 1 is a flow diagram 100 illustrating a method of accessing a plurality of services using a service abstraction layer, according to an embodiment. At step 110, at least one request for accessing at least one service of a preregistered plurality of services is received from a service requestor at the service abstraction layer. In one embodiment, the plurality of services from one or more service providers, i.e., the services offered by the one or more service providers, is registered in a service registry of the service abstraction layer. The service providers can be within a particular landscape or it can be on the cloud, whereby shared service providers, software and information are provided to the service requestors on demand.

In one exemplary embodiment, the request is dynamically configured to include at least one of a type of service, a payload, a response callback handler type, a service requestor ID, a retry count, and a timeout period. The type of service (e.g., REST, SOAP, Web Service, and the like) defines the service provider to which the request needs to be forwarded. The payload defines data of the request to be processed. The response callback handler type defines an action to be performed after receiving a response, indicating successful execution of the requested service, from the corresponding service provider. In one exemplary embodiment, the response callback handler type can include at least one of updating a user interface (UI) of the service requestor with the response received from the corresponding service provider and storing the response from the corresponding service provider in a predetermined registry. Further, the service requestor ID is a reference of the service requestor making the request and can include information about the locale of the service requestor. The retry count defines the number of attempts to execute the request, if the request is not successfully executed by the service provider or defines a maximum number of retries before eventually abandoning the request. Furthermore, the timeout period defines a maximum period before aborting the request.

At step 120, the received at least one request is forwarded to at least one corresponding service provider of the one or more service providers by a service invoker of the service abstraction layer. In one exemplary embodiment, the received request is stacked in a queue by a queue manager and forwarded to the service invoker using a first-in-first-out approach. Therefore, managing the request via the queue facilitates resubmitting of failed requests. At step 130, a check is made to determine whether or not the requested service is successfully executed by the at least one corresponding service provider.

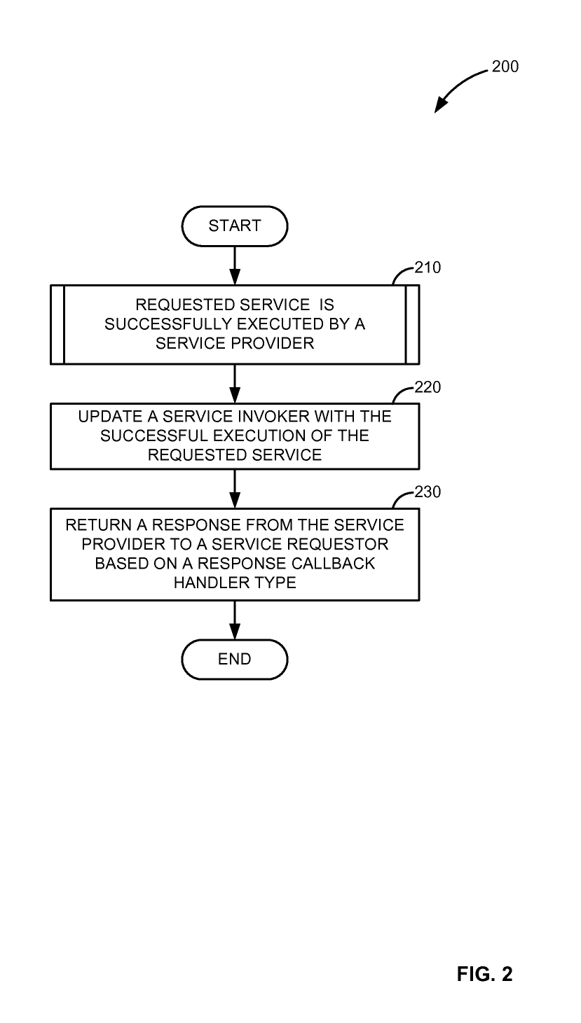

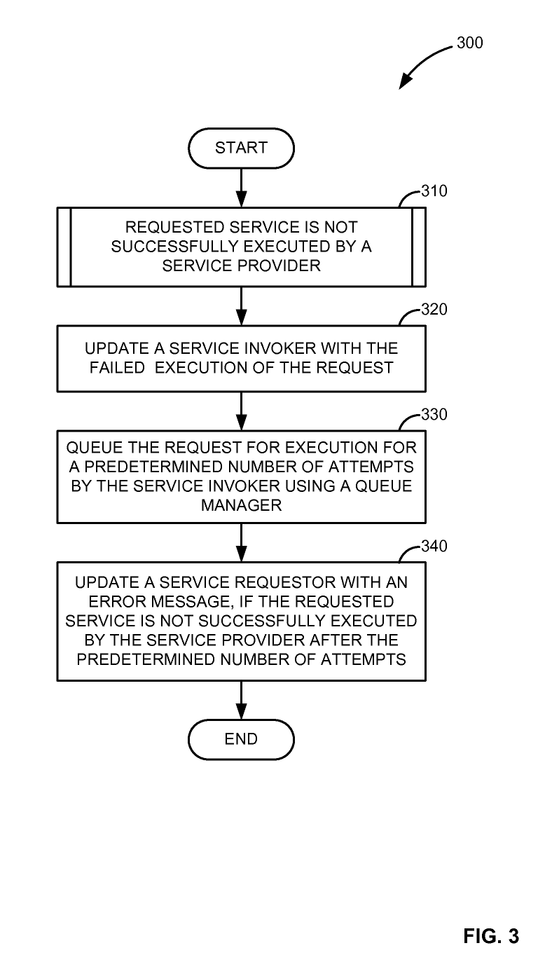

At step 140, a response from the at least one corresponding service provider is returned to the service requestor based on the determination (i.e., whether or not the requested service is successfully executed). The response from the corresponding service provider is returned to the service requestor via the service invoker of the service abstraction layer. In one exemplary embodiment, returning the response includes updating the user interface (UI) of the service requestor with the response received from the corresponding service provider and/or storing the response from the corresponding service provider in a predetermined registry, according to the response callback handler type. The process involved when the requested service is successfully executed is described in greater detail in FIG. 2 and the process involved when the requested service is not successfully executed is described in greater detail in FIG. 3.

FIG. 2 is a flow diagram 200 illustrating a method of implementation when a requested service is successfully executed by a service provider, according to an embodiment. At step 210, the requested service forwarded by a service invoker (as described in step 120 of FIG. 1) is successfully executed by the service provider. At step 220, the service invoker is updated about the successful execution of the requested service by the service provider.

At step 230, a response from the service provider is returned to a service requestor based on a response callback handler type. In one exemplary embodiment, returning the response includes updating a user interface (UI) of the service requestor with the response received from the corresponding service provider and/or storing the response from the corresponding service provider in a predetermined registry. Therefore, the service abstraction layer handles the response from the service provider to the service requestor by providing format conversion (e.g., formats such as XML, JSON, and the like) suitable to both the service requestor and the service provider. Similarly, a request for accessing a plurality of services from multiple service providers can also be handled by the service abstraction layer.

FIG. 3 is a flow diagram 300 illustrating a method of implementation when a requested service is not successfully executed by a service provider, according to an embodiment. At step 310, the requested service forwarded by a service invoker (as described in step 120 of FIG. 1) is not successfully executed by the service provider. In another exemplary embodiment, the service invoker may abort the request if there is no response from the service provider and a timeout period is completed. At step 320, the service invoker is updated with the failed execution of the requested service.

At step 330, the service invoker forwards the request to a queue for execution of the requested service by a queue manager for a predetermined number of attempts as per a retry count. Since, the received request is managed via the queue, it facilitates failed and timed out requests to retry execution. At step 340, the service requestor is updated with an error message if the requested service is not successfully executed by the service provider after the predetermined number of attempts. Also, for example if the service provider is down, the service abstraction layer handles the issue by retrying the execution of the requested service and thus, such concerns are handled by the service abstraction layer by managing error handling, timeouts or service interruptions, and the like.

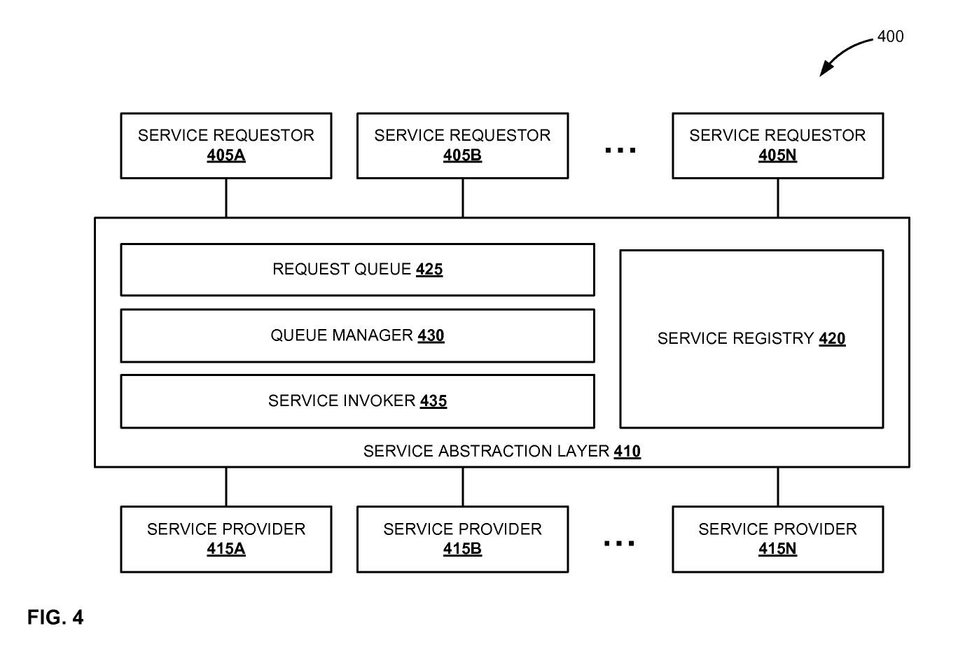

FIG. 4 is a block diagram of a conceptual illustration of a system 400 for accessing a plurality of services using a service abstraction layer, according to an embodiment. The system 400 includes one or more clients or service requestors (e.g., service requestors 405A to 405N) communicatively coupled to one or more service providers (e.g., service providers 415A to 415N) using the service abstraction layer 410. In one exemplary embodiment, the service requestor (e.g., service requestors 405A to 405N), the service provider (e.g., service providers 415A to 415N), and the service abstraction layer 410 can be located at different computer systems.

In one embodiment, the service abstraction layer 410 includes a service registry 420, a request queue 425, a queue manager 430, and a service invoker 435. The service registry 420 registers a plurality of services offered by the one or more service providers (e.g., service providers 415A to 415N). The request queue 425 receives at least one request for accessing at least one service of the registered plurality of services. The queue manager 430 manages the request queue and the life time of the request. The service invoker 435 acts as a service access point to forward the request to the one or more service providers (e.g., service providers 415A to 415N) and handle the response from the one or more service providers (e.g., service providers 415A to 415N).

In operation, the request is received for accessing at least one service of a preregistered plurality of services at the request queue 425 of the service abstraction layer 410. The requested service is executed at the service invoker 435 of the service abstraction layer 410 by forwarding to at least one corresponding service provider of the one or more service providers (e.g., service providers 415A to 415N). In one exemplary embodiment, the received request is stacked in a queue by a queue manager 430 and forwarded to the service invoker 435 using a first-in-first-out approach. Further, the service invoker 435 determines whether or not the requested service is successfully executed by the at least one corresponding service provider. Also, if the timeout period is completed without receiving the response from the corresponding service providers, the service invoker 435 aborts the request. Further, for failed execution and aborted requests, the service abstraction layer 410 retries executing of the requested service for the predetermined number of retry attempts.

Further in operation, the response from the at least one corresponding service provider (e.g., service providers 415A to 415N) is returned to the service requestor (e.g., service requestors 405A to 405N) based on the determination (e.g., whether or not the requested service is successfully executed). In one exemplary embodiment, returning the response includes updating a user interface (UI) of the service requestor with the response received from the corresponding service provider and/or storing the response from the corresponding service provider in a predetermined registry, according to the response callback handler type. In general, the service abstraction layer 410 provides a clean contact between UI developers (service requestors (e.g., service requestors 405A to 405N)) and functional programmers (service providers (e.g., service providers 415A to 415N)) by bringing the information from different service providers (e.g., service providers 415A to 415N) into a common plane (e.g., service abstraction layer 410) to do specific tasks. Also, the service abstraction layer 410 allows for a loosely coupled development cycle that limits critical dependencies and ensures that new front-ends can be easily applied to existing functionality. Further, the service abstraction layer 410 eliminates repeated code changes required for managing communication infrastructure between the service requestors (e.g., service requestors 405A to 405N) and the service providers (e.g., service providers 415A to 415N) and thus, enhances application design for better user feedback. Furthermore, the service abstraction layer 410 simplifies change management when various service providers' change as the service abstraction layer 410 enables the rapid adoption of new client technologies.

Few potential use cases to describe how a plurality of services can be accessed using a service abstraction layer are described below. In one exemplary application, using a single request, the service abstraction layer can transmit the command to the different service providers. For example, a request to delete an account in one or more applications such as Facebook®, Orkut®, Twitter®, and the like can be achieved with a single request. The service abstraction layer forwards the request to corresponding service providers to execute the request. Therefore, the service abstraction layer handles the command to multiple service providers with the single request and thus, with the single request, multiple tasks can be achieved.

In another exemplary application, a given company may have a broad and well-established portfolio of enterprise applications. Across this portfolio, different products and suites may utilize different client technologies, such as HTML5, Flash, Silverlight, Legacy, and the like. This landscape may consist of islands of monolithic client functionality and an inevitable inertia against change. In such a scenario, the service abstraction layer acts as a centralized layer to handle communication between a client and the multiple enterprise applications.

In yet another exemplary application, consider a scenario when a business enterprise wants to enable an ordering tool for a seasonal product such as ice-cream. The online client for this tool is a mash-up of a weather service, an ordering service and a delivery service. Using the service abstraction layer, each of these services exposes a common, interchangeable data exchange format so that ad hoc interaction is possible. In addition, the company can select a client technology based solely on the particular requirements of the immediate business need. For example, they may choose a rich technology like Flash for a desktop application and then roll out a handheld mash up using HTML5 without having to do any re-engineering of the business services.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

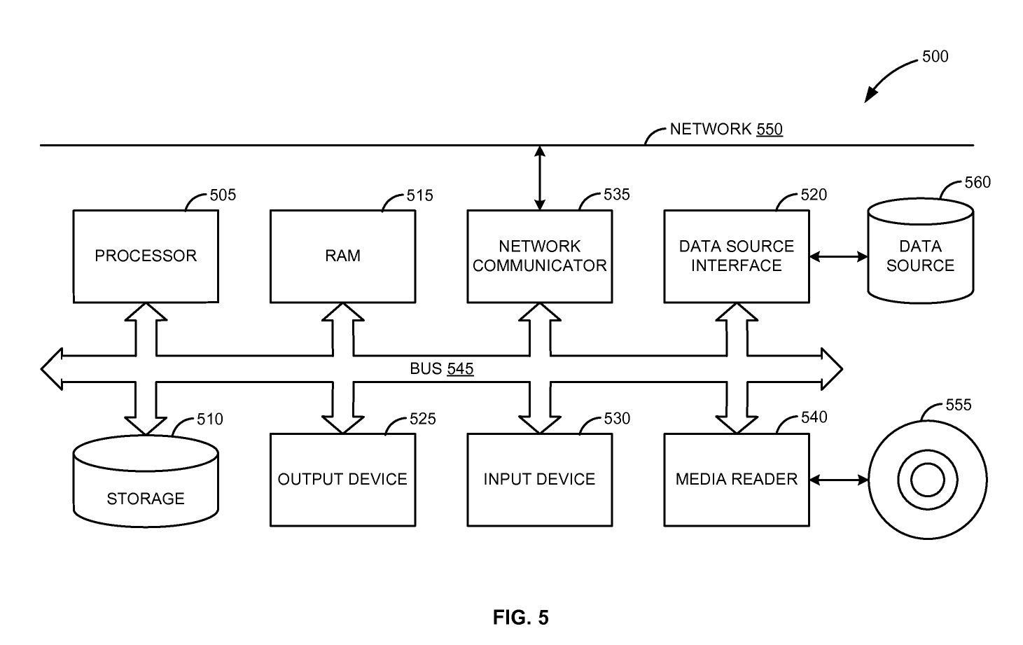

FIG. 5 is a block diagram of an exemplary computer system 500. The computer system 500 includes a processor 505 that executes software instructions or code stored on a computer readable storage medium 555 to perform the above-illustrated methods of the invention. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment of the invention, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
receive, at a service abstraction layer, at least one request from a service requestor for accessing at least one service of a preregistered plurality of services;
forward, at a service invoker of the service abstraction layer, the received at least one request to at least one corresponding service provider;
determine, at the service invoker, whether the at least one requested service is successfully executed by the at least one corresponding service provider; and
based on the determination, return a response from the at least one corresponding service provider to the service requestor.

2. The article of manufacture of claim 1, wherein the plurality of services from one or more service providers are registered in a service registry of the service abstraction layer.

3. The article of manufacture of claim 1, wherein the received at least one request is stacked by a queue manager and the at least one request is forwarded to the service invoker using a first-in-first-out approach.

4. The article of manufacture of claim 1, wherein the at least one request is dynamically configured to comprise at least one of a type of service, a payload, a response callback handler type, a service requestor ID, a retry count, and a timeout period.

5. The article of manufacture of claim 1, wherein returning the response comprises at least one of updating a user interface (UI) of the service requestor with a response received from the at least one corresponding service provider and storing the response received from the at least one corresponding service provider at a predetermined registry, if the at least one request is successfully executed by the at least one corresponding source.

6. The article of manufacture of claim 1, wherein returning the response comprises queuing the at least one request for execution for a predetermined number of attempts, if the at least one requested service is not successfully executed by the at least one corresponding service provider.

7. The article of manufacture of claim 6, wherein returning the response further comprises updating the service requestor with an error message, if the at least one requested service is not successfully executed by the at least one corresponding service provider after the predetermined number of attempts.

8. A computerized method for accessing a plurality of services from one or more sources using a service abstraction layer, the method comprising:
receiving, at the service abstraction layer, at least one request from a service requestor for accessing at least one service of the preregistered plurality of services;
forwarding, at the service invoker of the service abstraction layer, the received at least one request to at least one corresponding service provider;
determining, at the service invoker, whether the at least one requested service is successfully executed by the at least one corresponding service provider; and
based on the determination, returning a response from the at least one corresponding service provider to the service requestor.

9. The computerized method of claim 8, wherein the plurality of services from one or more service provider are registered in a service registry of the service abstraction layer.

10. The computerized method of claim 8, wherein the received at least one request is stacked by a queue manager and the at least one request is forwarded to the service invoker using a first-in-first-out approach.

11. The computerized method of claim 8, wherein the at least one request is dynamically configured to comprise at least one of a type of service, a payload, a response callback handler type, a service requestor ID, a retry count, and a timeout period.

12. The computerized method of claim 8, wherein returning the response comprises at least one of updating a user interface (UI) of the service requestor with a response received from the at least one corresponding service provider and storing the response received from the at least one corresponding service provider at a predetermined registry, if the at least one requested service is successfully executed by the at least one corresponding service provider.

13. The computerized method of claim 8, wherein returning the response comprises queuing the at least one request for execution for a predetermined number of attempts, if the at least one requested service is not successfully executed by the at least one corresponding service provider.

14. The computerized method of claim 13, wherein returning the response further comprises updating the service requestor with an error message, if the at least one requested service is not successfully executed by the at least one corresponding service provider after the predetermined number of attempts.

15. A computer system for accessing a plurality of services from one or more sources using a service abstraction layer, the system comprising:
a processor;
a memory coupled to the processor to store program code; and
the service abstraction layer residing in the memory, wherein the service abstraction layer comprises:
a service registry for registering the plurality of services from the one or more service provider;
a request queue to receive a request from a service requestor for accessing at least one service, from the registered plurality of services; and
a service invoker to forward the received at least one request to at least one corresponding service provider of the one or more service provider, receiving a response from the at least one corresponding service provider, and forwarding the response to the service requestor.

16. The computer system of claim 15, further comprising a queue manager to stack the received at least one request and to forward the at least one request to the service invoker using a first-in-first-out approach.

17. The computer system of claim 15, wherein the at least one request is dynamically configured to comprise at least one of a type of service, a payload, a response callback handler type, a service requestor ID, a retry count, and a timeout period.

18. The computer system of claim 15, wherein returning the response comprises at least one of updating a user interface (UI) of the service requestor with a response received from the at least one corresponding service provider and storing the response received from the at least one corresponding service provider at a predetermined registry, if the at least one requested service is successfully executed by the at least one corresponding service provider.

19. The computer system of claim 15, wherein returning the response comprises queuing the at least one request for execution for a predetermined number of attempts, if the at least one requested service is not successfully executed by the at least one corresponding service provider.

20. The computer system of claim 19, wherein returning the response further comprises updating the service requestor with an error message, if the at least one requested service is not successfully executed by the at least one corresponding service provider after the predetermined number of attempts.
